(19) United States
(12) Patent Application Publication
(10) Pub. No.: US 2019/0095921 A1
(43) Pub. Date: Mar. 28, 2019

(54) METHOD AND SYSTEM FOR TRANSACTION SCORING VIA SOCIAL MEDIA INTEGRATION

(71) Applicant: Mastercard International Incorporated, Purchase, NY (US)

(72) Inventors: Manash BHATTACHARJEE, Jersey City, NJ (US); Prashant SHARMA, Madison, NJ (US); Joseph HAYES, Montclair, NJ (US)

(73) Assignee: Mastercard International Incorporated, Purchase, NY (US)

(21) Appl. No.: 15/715,678

(22) Filed: Sep. 26, 2017

(51) Int. Cl. G06Q 20/40; G06Q 50/00

(52) U.S. Cl. CPC G06Q 20/4016; G06Q 50/01

(57) ABSTRACT

A method for distributing a travel score includes: storing a plurality of account profiles, each including a primary account number, contact data values, and a home country; receiving itinerary data, the data including specific contact data values, a visiting country, and a travel date; identifying a specific account profile where included contact data values correspond to the specific contact data values; receiving a transaction message for a payment transaction including the primary account number included in the specific account profile, a transaction date, and a transacting country; calculating a travel score for the payment transaction based on at least (i) a correspondence between the transacting country and the visiting country, and (ii) proximity of the transaction date and the travel date; and transmitting the transaction message and the calculated travel score.

### FIELD

The present disclosure relates to the distribution of travel scores, specifically the use of itinerary data received via integration with social media or other avenues of correspondence to calculate a travel score for an electronic payment transaction that is distributed for use in determining likelihood of fraud for a cross-border payment transaction.

### BACKGROUND

Fraud prevention is often a major concern for issuing financial institutions and their consumers. In many cases, an issuing financial institution will analyze transaction data for a payment transaction that is attempted to determine the likelihood of fraud based on the transaction data and historical trends and information for the involved transaction account. One such piece of transaction data is the geographic location of the payment transaction. In many instances, a financial institution may reject a cross-border payment transaction conducted outside of the home country registered for a transaction account, due to the likelihood of fraud in such cases.

In these instances, the consumer must inform their issuing institution prior to their travels that they will be leaving the country. However, such a process may be cumbersome and inconvenient for the consumer. In addition, a consumer may forget to inform their issuing institution ahead of time, and may be unable to easily contact their issuing institution when traveling, which may in turn place them in a foreign country without the ability to conduct payment transactions. Existing transaction processing systems are unable to identify travel patterns for consumers, and thereby continue to require consumer participation in reducing the likelihood of fraud for cross-border transactions.

Thus, there is a need for a technological solution to enable transaction processing systems to identify when a consumer will be traveling to determine likelihood of fraud in cross-border transactions to protect consumers and issuing institutions from fraud without requiring active consumer participation.

### SUMMARY

The present disclosure provides a description of systems and methods for distributing a travel score. Itinerary information is received by a transaction processing system via integration with a social network, such as an e-mail account, where the itinerary information is cross-referenced with transaction data received for a cross-border payment transaction involving the consumer associated with the itinerary information. By using received itinerary information, an accurate travel score may be calculated for the transaction without the need for active participation in the system by the consumer. An issuing institution can then approve or deny a cross-border payment transaction with a more accurate indication of the likelihood of fraud with higher convenience and efficiency for both the issuing institution and the consumer.

A method for distributing a travel score includes: storing, in an account database of a processing server, a plurality of account profiles, wherein each account profile includes a standardized data set related to a transaction account including at least a primary account number, at least one contact data value, and a home country; receiving, by a receiving device of the processing server, itinerary data from a first computing system, wherein the itinerary data includes one or more specific contact data values, a visiting country, and a travel date; executing, by a querying module of the processing server, a query on the account database to identify a specific account profile where included contact data values correspond to the one or more specific contact data values; receiving, by the receiving device of the processing server, a transaction message for a payment transaction via payment rails, wherein the transaction message is formatted based on one or more standards and includes a plurality of data elements including at least a first data element configured to store the primary account number included in the specific account profile, a second data element configured to store a transaction date, and a third data element configured to store a transacting country; calculating, by a calculation module of the processing server, a travel score for the payment transaction based on at least (i) a correspondence between the transacting country and the visiting country, and (ii) proximity of the transaction date and the travel date; and electronically transmitting, by a transmitting device of the processing server, at least the transaction message and the calculated travel score to a second computing system.

A system for distributing a travel score includes: querying module of a processing server; a calculation module of the processing server; a transmitting device of the processing server; an account database of the processing server configured to store a plurality of account profiles, wherein each account profile includes a standardized data set related to a transaction account including at least a primary account number, at least one contact data value, and a home country; and a receiving device of the processing server configured to receive itinerary data from a first computing system, wherein the itinerary data includes one or more specific contact data values, a visiting country, and a travel date, wherein the querying module of the processing server is configured to execute a query on the account database to identify a specific account profile where included contact data values correspond to the one or more specific contact data values, the receiving device of the processing server is further configured to receive a transaction message for a payment transaction via payment rails, wherein the transaction message is formatted based on one or more standards and includes a plurality of data elements including at least a first data element configured to store the primary account number included in the specific account profile, a second data element configured to store a transaction date, and a third data element configured to store a transacting country, the calculation module of the processing server is configured to calculate a travel score for the payment transaction based on at least (i) a correspondence between the transacting country and the visiting country, and (ii) proximity of the transaction date and the travel date, and the transmitting device of the processing server is configured to electronically transmit at least the transaction message and the calculated travel score to a second computing system.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for distributing travel scores for cross-border transactions using itinerary information in accordance with exemplary embodiments.

FIG. 2 is a block diagram illustrating the processing server of the system of FIG. 1 for distributing a travel score for a cross-border transaction in accordance with exemplary embodiments.

FIG. 3 is a flow diagram illustrating a process for the receipt and storage of itinerary information for a transaction account in the system of FIG. 1 in accordance with exemplary embodiments.

FIG. 4 is a flow diagram illustrating a process for the calculation and distribution of a travel score for a cross-border transaction in the system of FIG. 1 in accordance with exemplary embodiments.

FIG. 5 is a flow chart illustrating an exemplary method for distributing a travel score in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below. System for Distribution of Travel Scores for Cross-Border Transactions.

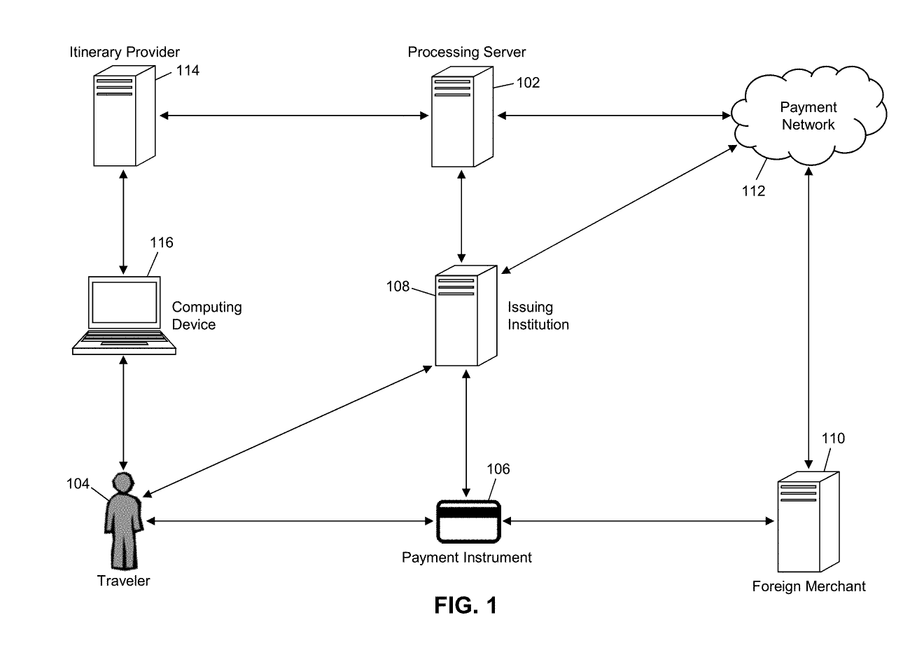

FIG. 1 illustrates a system 100 for the distribution of travel scores for cross-border transactions based on itinerary information received via integration with social media for a consumer associated with a transaction account involved in the cross-border transaction.

The system 100 may include a processing server 102. The processing server 102, discussed in more detail below, may be configured to calculate and distribute travel scores for cross-border transactions based on itinerary information. In the system 100, a traveler 104 may be issued a payment instrument 106 for a transaction account that may be used to fund electronic payment transactions, including for cross-border payment transactions. The traveler 104 may be issue the transaction account and corresponding payment instrument 106 by an issuing institution 108, which may be any type of institution, such as an issuing bank, configured to issue transaction accounts and participating in the processing of payment transactions funded by such accounts. A cross-border payment transaction may be a payment transaction conducted in a country other than a home country of the transaction account, which may be determined via data included in the payment transaction as received during processing thereof, as discussed below.

The traveler 104 may be from a first country, referred to herein as their home country, and may travel to a second country, also referred to herein as the foreign country, and initiate a payment transaction with a foreign merchant 110. The foreign merchant 110 may be a merchant located in the second country that accepts the payment instrument 106 for funding of payment transactions. The foreign merchant 110 may initiate processing of the cross-border payment transaction using traditional methods and systems. As part of the processing, the foreign merchant 110 may electronically transmit transaction data for the payment transaction to a payment network 112 for processing. The payment network 112 may receive a transaction message for the payment transaction, which may be generated by the foreign merchant 110 and transmitted directly to the payment network 112 via payment rails associated therewith, may be generated by an acquiring institution operating on behalf of the foreign merchant 110 and transmitted to the payment network 112 via transaction data supplied by the foreign merchant 110, or may be generated by the foreign merchant 110 and transmitted via the acquiring institution or other intermediary entity.

The transaction message may be a specially formatted data message that is formatted pursuant to one or more standards governing the exchange of financial transaction messages, such as the International Organization of Standardization's ISO 8583 or 20022 standards. A transaction message may include a message type indicator indicative of the type of transaction message and a plurality of data elements, wherein each data element is configured to store transaction data as set forth in the appropriate standard(s). In some cases, a transaction message may include one or more bitmaps, which may be configured to indicate the data elements included in the transaction message and the data stored therein. In the system 100, the payment network 112 may receive a transaction message with a message type indicator indicative of an authorization request and a plurality of data elements including at least a first data element configured to store a primary account number associated with the transaction account corresponding to the payment instrument 106, a second data element configured to store a transaction date, and a third data element configured to store the second country. In some cases, the data elements may further include a data element configured to store a transaction time.

The payment network 112 may receive the authorization request from the foreign merchant 110 via the payment rails associated therewith. The payment network 112 may then forward the authorization request to the processing server 102. In some embodiments, the processing server 102 may be a part of the payment network 112 and receive the authorization request via internal communication of the payment network 112. In other embodiments, the processing server 102 may be external to the payment network 112 and receive the authorization request via the payment rails associated therewith or another suitable communication network and method. The processing server 102 may receive the authorization request and may be configured to calculate a travel score for the payment transaction. Traditionally, a travel score may be based on transaction data stored in the data elements included in the authorization request and historical data associated with the transaction account stored in the processing server 102. Such historical data may include, for example, the home country of the transaction account and transaction data of past payment transactions.

The system 100 may further include an itinerary provider 114. The itinerary provider 114 may be and entity configured to receive travel itineraries associated with travelers 104. In some embodiments, the itinerary provider 114 may be an e-mail provider or other type of social network that may receive a travel itinerary following purchase thereof by the traveler 104, such as an e-mail confirmation following the purchase of air travel or hotel accommodations. For instance, the traveler 104 may use a computing device 116 (e.g., a desktop computer, laptop computer, tablet computer, notebook computer, cellular phone, smart phone, smart watch, smart television, etc.) to make a travel-related purchase, and may receive a travel itinerary via the itinerary provider 114. For example, the itinerary provider 114 may be an e-mail provider and the traveler 104 may receive a travel itinerary via their e-mail, accessible by their computing device 116.

The itinerary provider 114 may be configured to electronically transmit the itinerary data for the received itinerary to the processing server 102 using a suitable communication network and method. For instance, if the traveler 104 uses Google® e-mail, Google can update the traveler's calendar. See, U.S. Patent Application No. 20130124238 to Burrows et al., incorporated herein by reference. Alternatively or additionally, a flight related search can be detected and a flights search interface presented. See, U.S. Patent Application No. 2014/0052714 to Brodziak et al., incorporated herein by reference. The itinerary detected or resulting from this interface can then be converted to a standard form by the itinerary provider 114 to the processing server 102. The itinerary data may include data associated with the itinerary, such as a travel date, travel time, departure country, arrival country, place of lodging, length of stay, etc. As will be apparent to persons having skill in the relevant art, the data included in the itinerary data may vary based on the type of itinerary (e.g., an air travel itinerary may include different data than a hotel itinerary). The itinerary provider 114 may also electronically transmit known contact data associated with the traveler 104 to the processing server 102. The contact data may be data associated with the traveler 104 that may or may not be unique to the travel itinerary, such as the traveler's name, home address, zip code, postal code, telephone number, birth date, other demographic information, etc. The processing server 102 may receive the itinerary data and contact data values and may store the data in a database of the processing server 102.

The processing server 102 may also receive account data for the transaction account from the issuing institution 108. The account data may include data associated with the payment instrument 106 corresponding thereto, such as the primary account number, expiration date, cardholder name, security code, etc., additional account data, such as home country, currency type, etc., and may also include contact data possessed by the issuing institution 108, such as the account holder's (e.g., traveler's) name, mailing address, birth date, zip code, postal code, telephone number, etc. The processing server 102 may receive the account data for the transaction account and may store it in an account profile of an account database included therein, as discussed in more detail below.

When the processing server 102 receives the authorization request for the payment transaction, the processing server 102 may identify the account profile for the transaction account involved in the payment transaction, based on at least the primary account number stored in the corresponding data element included in the authorization request. The processing server 102 may then attempt to identify an itinerary associated with the transaction account. In some instances, such an attempt may only be made if the payment transaction is a cross-border transaction. A cross-border transaction may be identified based on the home country stored in the account profile and the transaction country of the payment transaction as indicated in the corresponding data element included in the authorization request.

The identification of an itinerary may be performed based on the contact data stored in the account profile as identified and associated with the payment transaction, and the contact data stored in the received itinerary data. If there is no correspondence between the contact data, then an associated itinerary will not be found. If there is a correspondence (e.g., both the itinerary data and account data include the same name, birthdate, and address for the associated traveler 104), then the travel itinerary may be considered to correspond to the payment transaction. The processing server 102 may then calculate a travel score based on the itinerary data and the transaction data stored in the data elements included in the authorization request. The travel score may be an indication of the likelihood of fraud, where the score may go up (e.g., or down, as applicable) as the likelihood of fraud increases (e.g., or decreases, as applicable). The travel score may be based on at least (i) a correspondence between the country being visited according to the itinerary data and the transacting country indicated in the authorization request, and (ii) the proximity of the travel date according to the itinerary data and the transaction date. Additional data may be used, as may be based on the level of detail included in the itinerary data. For instance, if the itinerary data includes an arrival time in the country being traveled to, the transaction time may be taken into account (e.g., where the likelihood of fraud may be higher if the transaction is conducted before the traveler 104 is supposed to arrive in the second country).

Once a travel score is calculated, the processing server 102 may electronically transmit the calculated travel score to the issuing institution 108 that issued the transaction account used in the payment transaction. In some embodiments, the travel score may be electronically transmitted along with the authorization request to the issuing institution 108. In some such embodiments, the travel score may be first distributed to the payment network 112, which may forward the travel score to the issuing institution 108 with the authorization request. In some cases, the travel score may be stored in a data element included in the authorization request. The issuing institution 108 may receive the authorization request and may determine approval or denial of the payment transaction using the travel score in addition to traditional fraud considerations and other criteria, such as the credit available to the traveler 104, etc. The issuing institution 104 may return an authorization response for the payment transaction to the payment network 112 that indicates approval or denial, which may then be forwarded to the foreign merchant 110. The foreign merchant 110 may then finalize the payment transaction, such as by providing the transacted-for goods or services to the traveler 104.

The processing server 102 may thus enable an issuing institution 108 to have a more accurate approximation of the likelihood of fraud for a cross-border payment transaction, which may take into account travel plans of the traveler 104, but without requiring the traveler 104 to actively participate. As a result, the traveler 104 may be able to more freely transact when they travel without having to contact the issuing institution 108 prior to traveling, and without having to perform any actions outside of their travel plans. As a result, fraud may be reduced while also reducing the number of actions and number of communications that must be performed by the issuing institution 108 and the traveler 104.

### Processing Server

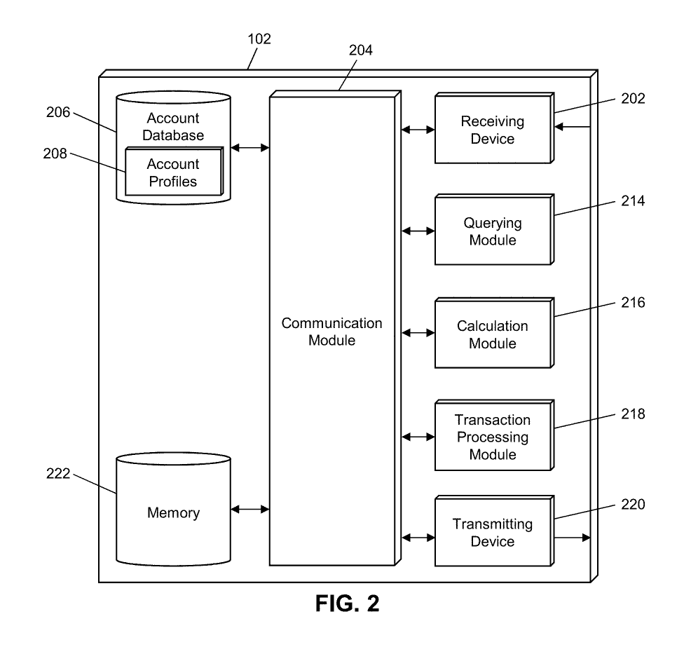

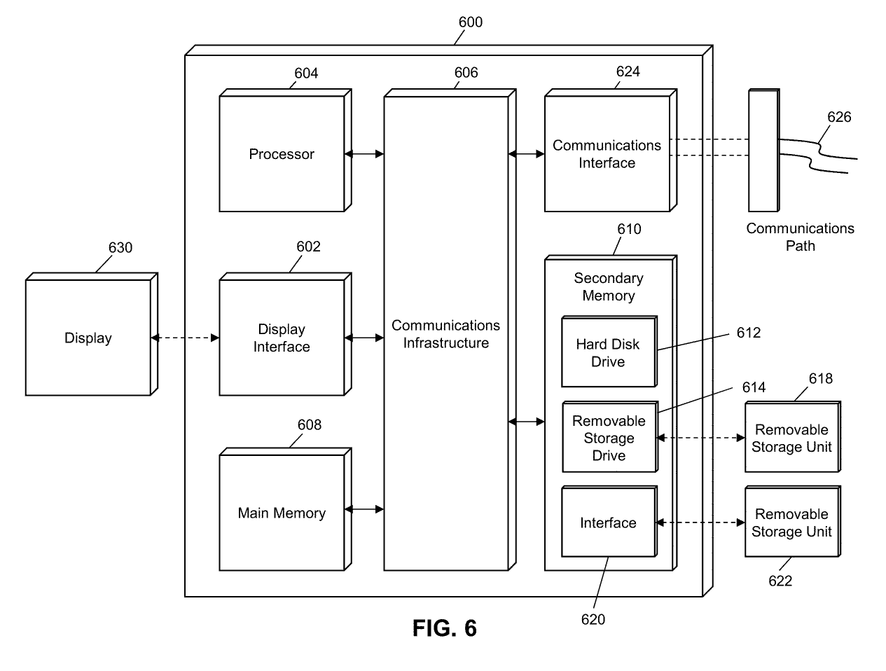

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from issuing institutions 108, itinerary providers 114, payment networks 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 108, which may be superimposed or otherwise encoded with transaction account data, which may include at least a primary account number, home country, and contact data values associated with the traveler 104 corresponding to the transaction account. The receiving device 202 may also be configured to receive data signals electronically transmitted by itinerary providers 114, which may be superimposed or otherwise encoded with itinerary data and contact data associated with a travel-related itinerary purchase or otherwise booked by the traveler 104. The receiving device 202 may be further configured to receive data signals electronically transmitted by payment networks 112, which may be transmitted via payment rails associated therewith, and which may be superimposed or otherwise encoded with transaction messages, such as authorization requests that include data elements configured to store at least primary account numbers, transaction dates, and transacting countries.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, calculation module 216, transaction processing module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. An account profile 208 may include at least a primary account number and home country for the related transaction account and one or more contact data values, which may be associated with an individual (e.g., the traveler 104) corresponding to the related transaction account.

The processing server 102 may include a querying module 214. The querying module 214 may be configured to execute queries on databases to identify information. The querying module 214 may receive one or more data values or query strings, and may execute a query string based thereon on an indicated database, such as the account database 206, to identify information stored therein. The querying module 214 may then output the identified information to an appropriate engine or module of the processing server 102 as necessary. The querying module 214 may, for example, execute a query on the account database 206 to identify an account profile 208 related to a transaction account involved in a payment transaction based on the primary account number stored therein, and may also be configured to identify travel itineraries corresponding to an account profile 208 based on contact data values.

The processing server 102 may also include a calculation module 216. The calculation module 216 may be configured to perform calculations as part of the functions of the processing server 102 as discussed herein. The calculation module 216 may receive an instruction as input, may perform the requested calculations, and may output the calculation results to one or more modules or engines of the processing server 102. The calculation module 216 may be configured, for example, to calculate a travel score for a payment transaction based on correspondences between the data stored in the data elements included in an authorization request and the itinerary data included in a received travel itinerary.

The processing server 102 may also include a transaction processing module 218. The transaction processing module 218 may be configured to perform functions related to the processing of an electronic payment transaction, such as will be apparent to persons having skill in the relevant art. Such functions may include, for example, the routing of transaction messages, the parsing and/or updating of data elements included in a transaction message, fraud determinations, application of transaction controls, etc.

The processing server 102 may also include a transmitting device 220. The transmitting device 220 may be configured to transmit data over one or more networks via one or more network protocols. In some instances, the transmitting device 220 may be configured to transmit data to issuing institutions 108, itinerary providers 114, payment networks 112, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to issuing institutions 108, which may be superimposed or otherwise encoded with travel scores, which may be accompanied by or included in authorization requests. The transmitting device 220 may also be configured to electronically transmit data signals to itinerary providers 114, such as may be superimposed or otherwise encoded with data requests, such as may include contact data values for the identification of a travel itinerary associated therewith. In some instances, the transmitting device 220 may also be configured to electronically transmit data signals to the payment network 112, such as via payment rails associated therewith, such as may be superimposed or otherwise encoded with authorization responses received from issuing institutions 108 for forwarding to the payment network 112.

The processing server 102 may also include a memory 222. The memory 222 may be configured to store data for use by the processing server 102 in performing the functions discussed herein, such as public and private keys, symmetric keys, etc. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 222 may be comprised of or may otherwise include a relational database that utilizes structured query language for the storage, identification, modifying, updating, accessing, etc. of structured data sets stored therein. The memory 222 may be configured to store, for example, itinerary data and contact data associated with travel itineraries as received from itinerary providers 114.

### Process for Receipt and Storage of Travel Itinerary Data

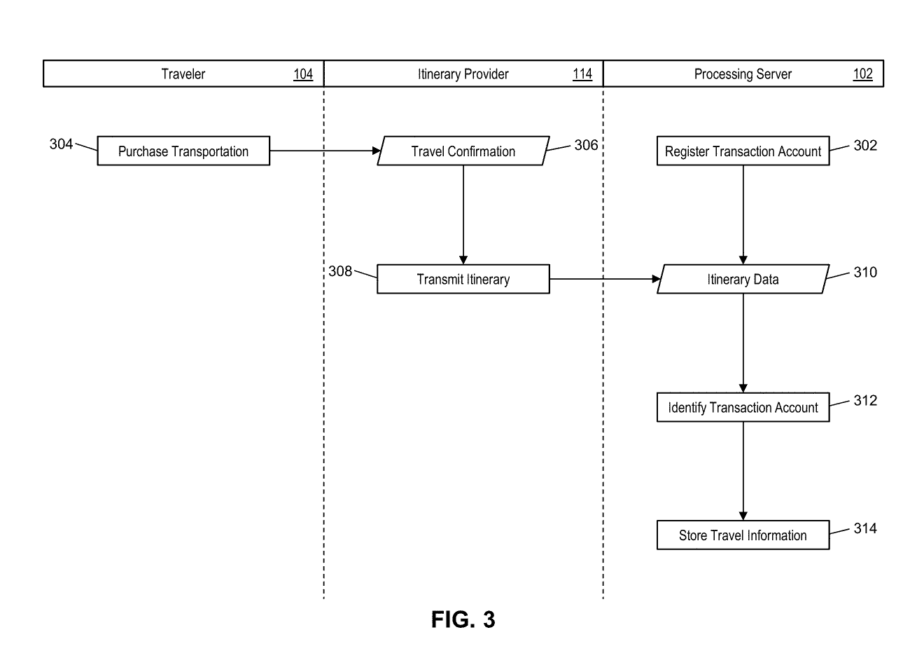

FIG. 3 illustrates a process 300 for the receipt of travel itinerary data related to travel secured by the traveler 104 in the system 100 for use in the calculation of a travel score for cross-border payment transactions involving a related transaction account.

In step 302, the processing server 102 may register the transaction account associated with the traveler 104, by executing, by the querying module 214 of the processing server 102, a query on the account database 206 to insert a new account profile 208 that includes the account data associated with the transaction account, as received (e.g., by the receiving device 202) from the issuing institution 108. In step 304, the traveler 104 may purchase transportation or make another travel-related purchase. As part of the purchase, in step 306, the itinerary provider 114, such as an e-mail provider or other social network, may receive travel confirmation for the travel. The travel confirmation may include itinerary data. The itinerary provider 114 may also possess contact data values associated with the traveler 104, which may be received in the travel confirmation. In step 308, the itinerary provider 114 may electronically transmit the itinerary data and contact data values to the processing server 102 using a suitable communication network and method.

In step 310, the receiving device 202 of the processing server 102 may receive the itinerary and contact data. The itinerary data may include at least a visiting country and travel date, and the contact data may include one or more data values associated with the traveler 104. In step 312, the querying module 214 of the processing server 102 may execute a query on the account database 206 to identify an account profile 208 where the contact data values stored therein correspond to the contact data values received from the itinerary provider 114. In step 314, the querying module 214 may execute a query on the account database 206 to insert the itinerary data to the matched account profile 208 stored therein.

### Process for Distribution of a Travel Score for Use in Transaction Processing

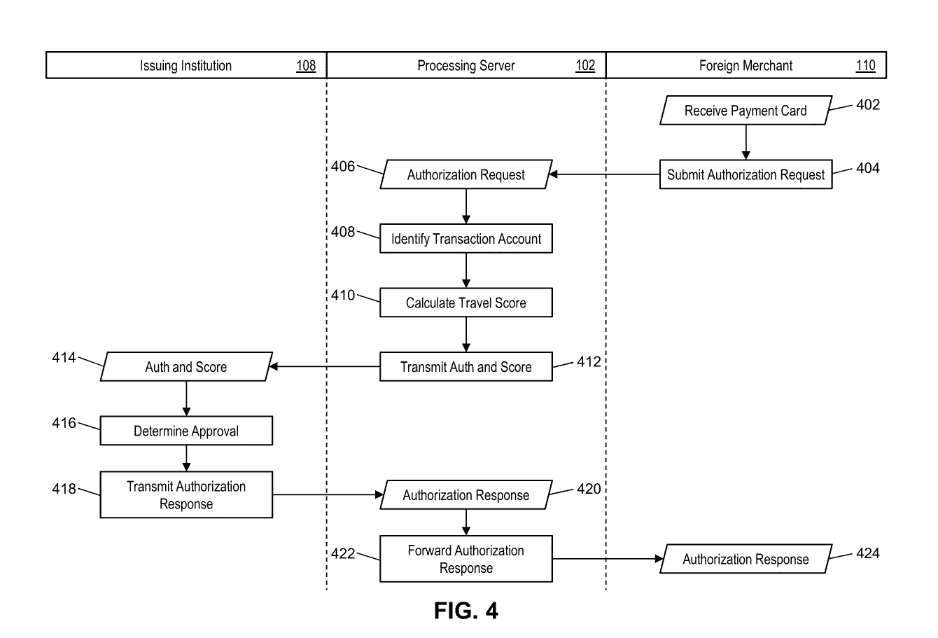

FIG. 4 illustrates a process for the calculation and distribution of a travel score for a cross-border payment transaction based on itinerary data and use thereof in processing of the transaction in the system 100.

In step 402, the foreign merchant 110 may receive the payment instrument 106 from the traveler 104 and read the payment credentials encoded therein or otherwise received therefrom. The payment credentials may include at least the primary account number corresponding to the related transaction account. In step 404, the foreign merchant 110 (e.g., or an acquiring institution or other entity associated therewith) may submit an authorization request for the cross-border payment transaction to the processing server 102 via the payment network 112 and the payment rails associated therewith. In step 406, the receiving device 202 of the processing server 102 may receive the authorization request, which may be a transaction message that includes a message type indicator indicative of an authorization request and include a plurality of data elements configured to store at least a primary account number, transaction date, and transacting country where the transaction takes place.

In step 408, the querying module 214 of the processing server 102 may execute a query on the account database 206 to identify an account profile 208 that includes the primary account number included in the authorization request. In step 410, the calculation module 216 of the processing server 102 may calculate a travel score for the payment transaction based on correspondences between the itinerary data stored in the account profile 208 and the transaction data, such as at least a correspondence between the destination country in the itinerary data and the transacting country and the proximity of the travel date to the transaction date. In step 412, the transmitting device 220 of the processing server 102 may electronically transmit the authorization request and the calculated travel score to the issuing institution 108, which may, in some cases, be forwarded through the payment network 112 and payment rails associated therein.

In step 414, the issuing institution 108 may receive the authorization request and the calculated travel score. In step 416, the issuing institution 108 may determine if the transaction is approved or denied, based on, in part, the calculated travel score, as well as traditional considerations, such as available account credit. In step 418, the issuing institution 108 may electronically transmit an authorization response for the payment transaction that indicates approval (e.g., or denial, as applicable) of the transaction to the processing server 102. In step 420, the receiving device 202 of the processing server 102 may receive the authorization response, which may be forwarded via the payment network 112 and the payment rails associated therewith.

In step 422, the transmitting device 220 of the processing server 102 may electronically transmit the authorization response to the foreign merchant 110, which may be forwarded via the payment network 112 and the payment rails associated therewith. In step 424, the foreign merchant 110 may receive the authorization response and finalize the transaction accordingly.

### Exemplary Method for Distributing a Travel Score

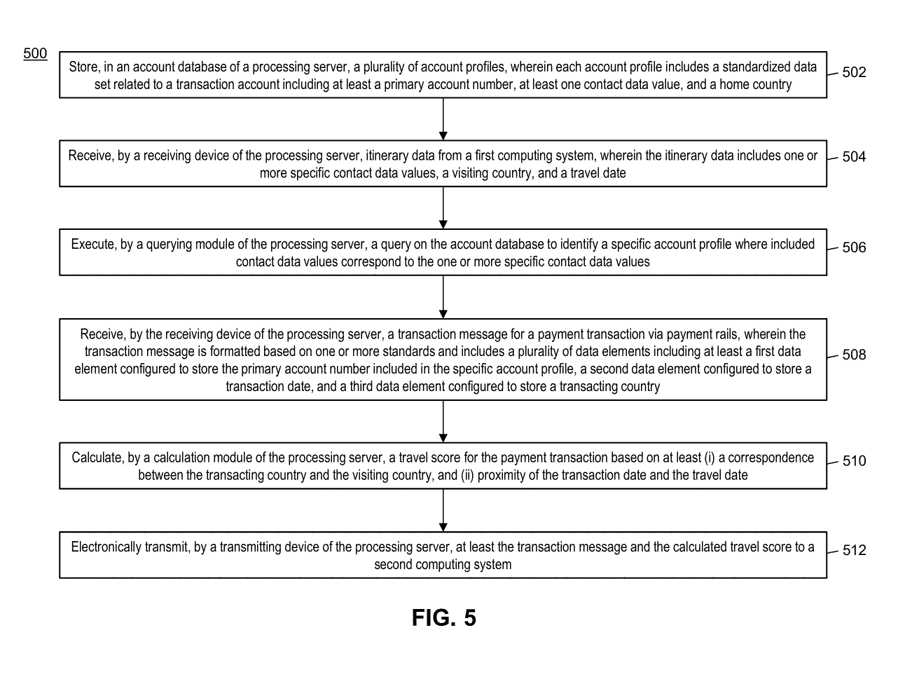

FIG. 5 illustrates a method 500 for the distribution of a travel score for a cross-border electronic payment transaction based on itinerary data and contact data associated with a transaction account.

In step 502, a plurality of account profiles (e.g., account profiles 208) may be stored in an account database (e.g., the account database 206) of a processing server (e.g., the processing server 102), wherein each account profile includes a standardized data set related to a transaction account including at least a primary account number, at least one contact data value, and a home country. In step 504, itinerary data may be received by a receiving device (e.g., the receiving device 202) of the processing server from a first computing system (e.g., the itinerary provider 114), wherein the itinerary data includes one or more specific contact data values, a visiting country, and a travel date.

In step 506, a query may be executed by a querying module (e.g., the querying module 214) of the processing server on the account database to identify a specific account profile where included contact data values correspond to the one or more specific contact data values. In step 508, a transaction message may be received by the receiving device of the processing server for a payment transaction via payment rails, wherein the transaction message is formatted based on one or more standards and includes a plurality of data elements including at least a first data element configured to store the primary account number included in the specific account profile, a second data element configured to store a transaction date, and a third data element configured to store a transacting country.

In step 510, a travel score may be calculated for the payment transaction by a calculation module (e.g., the calculation module 216) of the processing server based on at least (i) a correspondence between the transacting country and the visiting country, and (ii) proximity of the transaction date and the travel date. In step 512, at least the transaction message and the calculated travel score may be electronically transmitted by a transmitting device (e.g., the transmitting device 220) of the processing server to a second computing system (e.g., the issuing institution 108 or payment network 112).

In one embodiment, the travel date may be a period of time, and proximity of the transaction date and the travel date may be based on inclusion of the transaction date within the period of time. In some embodiments, the itinerary data may further include a mode of transportation and travel time, the plurality of data elements may further include a fourth data element configured to store a transaction time, and proximity of the transaction date and the travel date may include proximity of the transaction time to the travel time and is further based on the mode of transportation. In one embodiment, the one or more specific contact data values may include at least one of: name, e-mail address, residential address, zip code, postal code, telephone number, birth date, passport number, and known traveler number.

In some embodiments, the calculated travel score may be stored in one of the plurality of data elements included in the transaction message prior to electronic transmission. In one embodiment, the second computing system may be a financial institution managing the transaction account related to the specific account profile. In some embodiments, the transacting country may be different from the home country.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems.

Hardware, software, or any combination thereof may embody modules and components used to implement the methods of FIGS. 3-5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for distributing a travel score. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for distributing a travel score, comprising:
storing, in an account database of a processing server, a plurality of account profiles, wherein each account profile includes a standardized data set related to a transaction account including at least a primary account number, at least one contact data value, and a home country;
receiving, by a receiving device of the processing server, itinerary data from a first computing system, wherein the itinerary data includes one or more specific contact data values, a visiting country, and a travel date;
executing, by a querying module of the processing server, a query on the account database to identify a specific account profile where included contact data values correspond to the one or more specific contact data values;
receiving, by the receiving device of the processing server, a transaction message for a payment transaction via payment rails, wherein the transaction message is formatted based on one or more standards and includes a plurality of data elements including at least a first data element configured to store the primary account number included in the specific account profile, a second data element configured to store a transaction date, and a third data element configured to store a transacting country;
calculating, by a calculation module of the processing server, a travel score for the payment transaction based on at least (i) a correspondence between the transacting country and the visiting country, and (ii) proximity of the transaction date and the travel date; and
electronically transmitting, by a transmitting device of the processing server, at least the transaction message and the calculated travel score to a second computing system.

2. The method of claim 1, wherein
the travel date is a period of time, and
proximity of the transaction date and the travel date is based on inclusion of the transaction date within the period of time.

3. The method of claim 1, wherein
the itinerary data further includes a mode of transportation and travel time,
the plurality of data elements further includes a fourth data element configured to store a transaction time, and
proximity of the transaction date and the travel date includes proximity of the transaction time to the travel time and is further based on the mode of transportation.

4. The method of claim 1, wherein the one or more specific contact data values includes at least one of: name, e-mail address, residential address, zip code, postal code, telephone number, birth date, passport number, and known traveler number.

5. The method of claim 1, wherein the calculated travel score is stored in one of the plurality of data elements included in the transaction message prior to electronic transmission.

6. The method of claim 1, wherein the second computing system is a financial institution managing the transaction account related to the specific account profile.

7. The method of claim 1, wherein the transacting country is different from the home country.

8. A system for distributing a travel score, comprising:
querying module of a processing server;
a calculation module of the processing server;
a transmitting device of the processing server;
an account database of the processing server configured to store a plurality of account profiles, wherein each account profile includes a standardized data set related to a transaction account including at least a primary account number, at least one contact data value, and a home country; and
a receiving device of the processing server configured to receive itinerary data from a first computing system, wherein the itinerary data includes one or more specific contact data values, a visiting country, and a travel date, wherein
the querying module of the processing server is configured to execute a query on the account database to identify a specific account profile where included contact data values correspond to the one or more specific contact data values,
the receiving device of the processing server is further configured to receive a transaction message for a payment transaction via payment rails, wherein the transaction message is formatted based on one or more standards and includes a plurality of data elements including at least a first data element configured to store the primary account number included in the specific account profile, a second data element configured to store a transaction date, and a third data element configured to store a transacting country,
the calculation module of the processing server is configured to calculate a travel score for the payment transaction based on at least (i) a correspondence between the transacting country and the visiting country, and (ii) proximity of the transaction date and the travel date, and
the transmitting device of the processing server is configured to electronically transmit at least the transaction message and the calculated travel score to a second computing system.

9. The system of claim 8, wherein
the travel date is a period of time, and
proximity of the transaction date and the travel date is based on inclusion of the transaction date within the period of time.

10. The system of claim 8, wherein
the itinerary data further includes a mode of transportation and travel time,
the plurality of data elements further includes a fourth data element configured to store a transaction time, and
proximity of the transaction date and the travel date includes proximity of the transaction time to the travel time and is further based on the mode of transportation.

11. The system of claim 8, wherein the one or more specific contact data values includes at least one of: name, e-mail address, residential address, zip code, postal code, telephone number, birth date, passport number, and known traveler number.

12. The system of claim 8, wherein the calculated travel score is stored in one of the plurality of data elements included in the transaction message prior to electronic transmission.

13. The system of claim 8, wherein the second computing system is a financial institution managing the transaction account related to the specific account profile.

14. The system of claim 8, wherein the transacting country is different from the home country.
